(19) United States
(12) Patent Application Publication
(10) Pub. No.: US 2006/0291451 A1
(43) Pub. Date: Dec. 28, 2006

(54) Time-zone-synchronized Internet digital media management and distribution system

(76) Inventor: Donald J. Moore, New York, NY (US)

Correspondence Address: DONALD J. MOORE, 7 EAST 8TH STREET, # 157, NEW YORK, NY, 10003, US

(21) Appl. No.: 11/427,340

(22) Filed: Jun. 28, 2006

Related U.S. Application Data
(60) Provisional application No. 60/595,380, filed on Jun. 28, 2005.

(51) Int. Cl. H04L 12/66

(52) U.S. Cl. 370/352

(57) ABSTRACT

Internet and wireless network digital media management and distribution system, providing world-wide video viewing and/or audio listening automatically synchronized to the local time zone of the interconnected viewing or listening device, yielding a simultaneous viewing or listening experience within each time zone world-wide for video or audio programs and related multi-media content that are transmitted from a single source

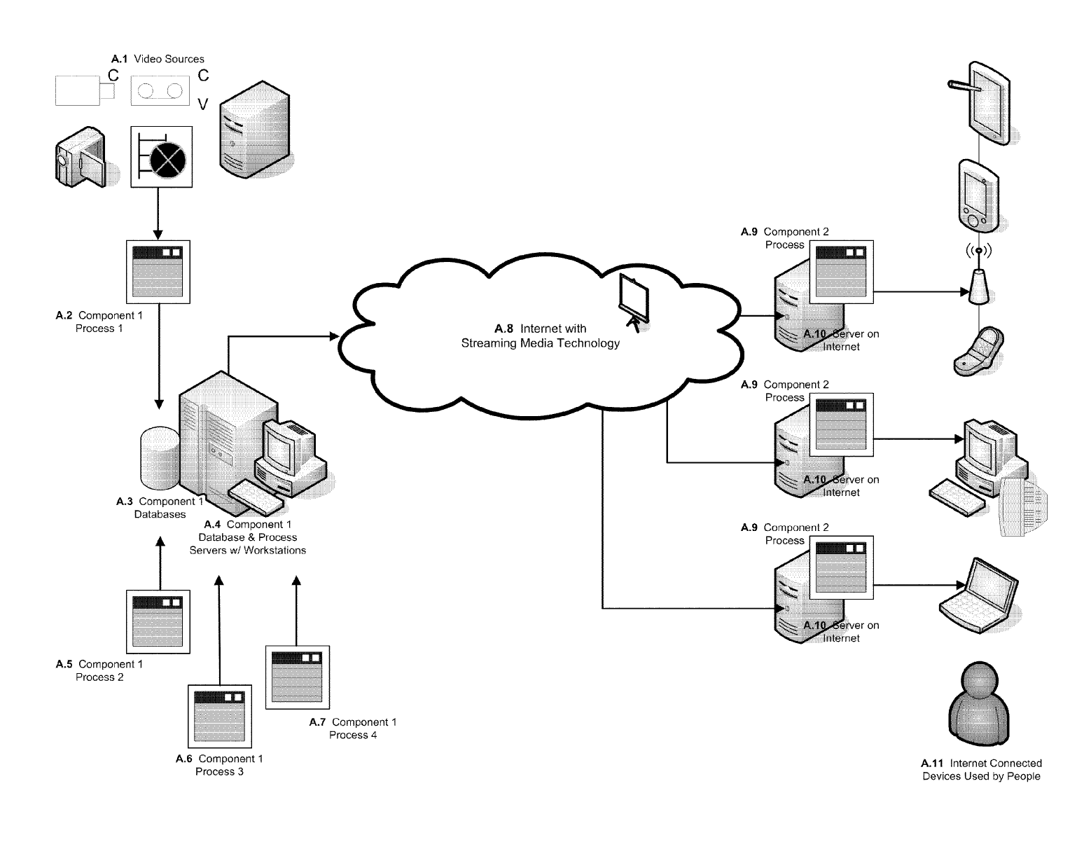

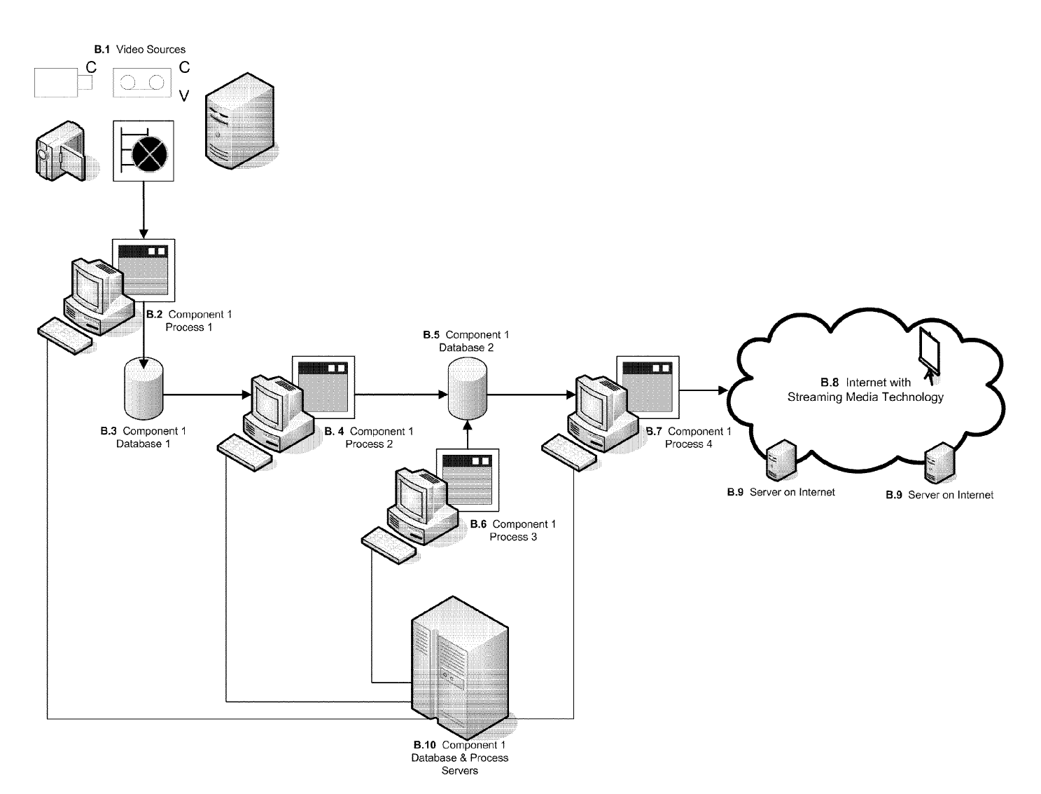

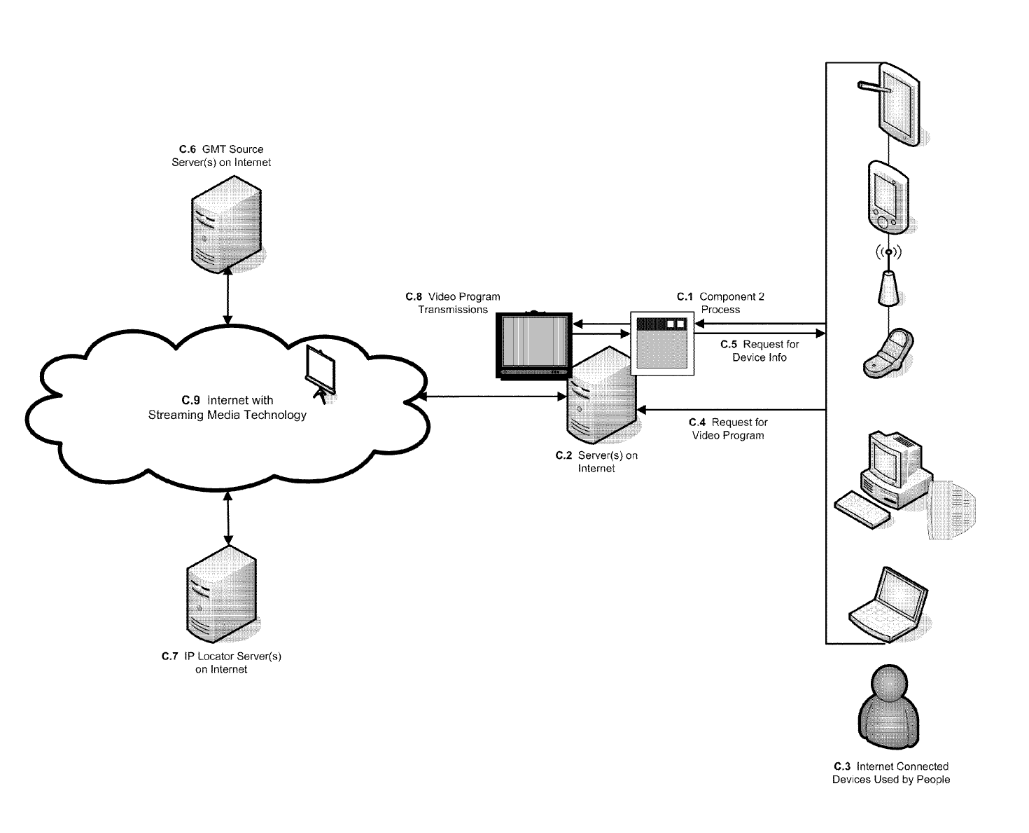

### FIELD OF THE INVENTION

Computer software for the management and distribution of digital media content via the Internet synchronized to world-wide time zones

### BACKGROUND OF THE INVENTION

The invention relates to watching video programs and listening to audio programs, along with multimedia content related to the programs, which are distributed to viewing and listening devices connected to the Internet.

The Internet is defined here as including wireless networks, such as cell phone and PDA networks, that are connected to the Internet.

Viewing and listening devices connected to the Internet include computers, computer-enabled televisions, personal digital assistants, cell phones, and other wired and wireless devices capable of viewing (listening to) digital media using industry-standard technology.

People sharing a common culture and language have historically tended to live in the same geographic location and within relatively few time zones.

Recently, however, people with a common cultural background and/or interests have become increasingly dispersed throughout all world-wide time zones, a trend many experts expect to intensify over the years ahead.

People, however spread out, still have a desire to connect to their common culture and share their common interests.

A significant unifying element in any given common culture, including the overall common culture of mankind, is to carry out certain common activities at certain times of the day relative to the time zone in which a person is living, or currently residing.

Simultaneously and collectively viewing video programs (listening to audio programs) and advertisements, such as on television (radio), is one principal means by which people stay connected with a shared culture.

The Internet and interconnected wireless networks span the globe and are accessible in virtually all world-wide time zones.

The Internet has done much to enable dispersed people with a common culture and/or interests to stay in touch with that culture or subject of interest.

The Internet, combined with ubiquitous additional technology from companies including Microsoft, Real Media, Macromedia, QuickTime, Speedera, VitalStream, and others, collectively referred to as “streaming media technology,” provides the ability for people to watch digital video (listen to digital audio) and related content on devices connected to the Internet. Streaming media technology is defined here as technology that continuously transmits digital video (audio) programs and related multimedia content from servers to devices via the Internet such that the programs can be viewed (listened to) as they are being transmitted.

Because of the inherent design of streaming media technology, video (audio) is distributed and viewed (listened to) on the Internet mainly in one of four ways:
(1) Video (audio) that is sourced from a digital video (audio) file on a server is viewed (listened to) on-demand, that is, it is viewed (listened to) after a person using a device connected to the Internet or a wireless network initiates a request to watch (listen to) the video (audio).
(2) Video (audio) that is sourced from a digital video (audio) file on a server is pushed in front of a person when he or she is using a device connected to the Internet or a wireless network, but is doing something else other than requesting to watch (listen to) a video (audio) program.
(3) Video (audio) that is sourced from cameras (microphones) at a live event and is transmitted around the Internet and wireless networks and is viewed (listened to) simultaneously and simultaneous to the event (subject to technical limits that may delay transmission) by any and all persons who choose to do so using a network-connected device.
(4) Video (audio) that is sourced from files on a server and is transmitted around the Internet and wireless networks and is viewed (listened to) simultaneously and simultaneous to the transmission (subject to technical limits that may delay transmission) by any and all persons who choose to do so using a network-connected device.

There is a compelling need for people with a common culture or common interests to watch (listen to) video (audio) programs simultaneously with other people who are living or residing within their time zone and whose lives are otherwise synchronized with that time zone.

The benefits of fulfilling this need, as exemplified by terrestrial broadcast, cable, or satellite television, are well known and need not be elaborated upon here.

The cultural need and resulting benefits are further amplified when people know that other people of common culture or interests who live in other time zones can watch (listen to) the same video (audio) programs at the same time of day relative to their own time zone, again, as evidenced by television (radio), such as when a program is broadcast at 8:00 p.m. on Sunday night in the US Eastern time zone and broadcast also at 8:00 p.m. on Sunday night in the US Pacific time zone.

This need, and the benefits derived there from, is intensifying, as people of common culture and interests move to time zones scattered around the world.

All of the aforementioned methods and practices for distributing and viewing (listening to) video (audio) programs on the Internet and interconnected wireless networks, however, fail to meet this important need.

Neither has this need been met with terrestrial broadcast, cable, or satellite television (radio) technology, primarily because such technology, though practical for several time zones, makes it impractical to transmit from a single source to all world-wide time zones, thus requiring multiple transmission sources, which also becomes impractical because of cost.

The Internet can provide a practical method for distributing video (audio) programs from one source to multiple world-wide locations, but, as discussed above, the Internet and streaming technology as presently constituted, provides either on-demand or simultaneous viewing.

The Internet and interconnected wireless networks and streaming media technology do, however, offer a potential means to meet this compelling need.

The invention presented here provides the technology to enable the Internet and streaming media technology to meet this need.

### SUMMARY OF THE INVENTION

The invention presented here is computer hardware and software system to manage and deliver multiple channels of digital video (audio) programs (which include advertisements) from a single source to widespread Internet-connected devices, while applying synchronized time zone offsets so that the same program can appear on the same channel at the same time each day (or each week, month, or with other periodic frequency) in every worldwide time zone.

The invention enables video (audio) program producers, sponsors of video (audio) programs, and audiences of video (audio) programs to know that a video (audio) program can be seen at the same time each day in each world-wide time zone. This is not currently accomplished on the Internet and interconnected wireless networks. The social and economic benefits of this are well-demonstrated by television (radio) across several time zones, but this invention extends those benefits using the Internet across all world-wide time zones.

The present invention consists of two components: Component 1—software programs and related databases residing on a server or servers that transmit video (audio) programs to the Internet at a sequence of pre-designated times, and Component 2—a software program residing on a server or servers to which a person connects to view the video (listen to the audio) programs so transmitted, and which automatically connects the viewer's device to the transmission designated for his or her time zone.

The Internet and digital streaming media technology is situated and functions between the two components of the invention described here.

### BRIEF DESCRIPTION OF DRAWINGS

Drawing A: Overall architecture of the Invention showing its relationship to the Internet and streaming media technology

Drawing B: Structure and processing of information through the first component of the invention to the Internet and streaming media technology

Drawing C: Structure and processing of information through the second component of the invention from the Internet and streaming media technology

### DETAILED DESCRIPTION OF THE INVENTION

In the following description of the Invention, references to the Drawings appear in parenthesis, so that (A.1) refers to Drawing A, part 1, and (A.2) refers to Drawing A, part 2, etc. The following description refers to video programs, files, and related devices, but the description applies as well to audio programs, files, and related devices. Video programs and audio programs include additional multimedia content that is related to and transmitted with the video or audio program.

With reference to Drawing A, the overall architecture of the Invention is structured as follows:

The Invention consists of computer software programs, called Processes in this document, and computer databases, called Databases in this document. The Processes and Databases run on, and are stored on, industry-standard computer servers (A.4) with interconnected workstations and audio/video devices.

Component 1: The first component of the Invention consists of Processes and Databases. The first Process (A.2) accept inputs of digital video files from various sources such as cameras, video players, servers, digitizing adaptors, etc. (A.1), and consolidates those files into a manageable database structure (A.3). A second Process (A.5) prepares the files to be distributed over the Internet, and a third Process (A.6) schedules the files for distribution through the Internet. A fourth Process (A.7) distributes the files to the Internet with streaming media technology. Using streaming media technology, the video programs represented by the digital video files, are transmitted (“broadcasted” ) by Process 4 according to the distribution channel(s) to which they are assigned, the time zone(s) in which they are designated to appear, and the time(s) within that time zone at which they are designated to play. A distribution channel is a sequential series of video programs that are available at a single distribution point, or Internet address, on an Internet-connected server(s).

The files travel over the Internet, utilizing the structure of the Internet and streaming media technology (A.8).

Component 2: The second component of the Invention consists of a Process. The Process (A.9) runs at points on servers (A.1O) connected to the Internet that are designated as distribution points where people using Internet connected devices (A.11) may connect, so that they can view a selected distribution channel(s) of video files processed and transmitted by the first Component of the Invention. When such Internet connected devices connect to points on servers running the Invention's Component 2 Process, the Process examines the device to determine its system time zone and time. It then connects the device to view the video program, using streaming media technology, represented by the video files designated through Invention Component 1 for distribution on that channel, in that time zone, at that time.

With reference to Drawing B, the detailed architecture of Component 1 of the Invention is structured as follows:

Component 1 of the Invention consists of four related computer software programs, called Processes in this document, and two related computer databases, called Databases in this document. The software takes inputs from a person, called a User in this document. The Processes and Databases run on, and are stored on, industry-standard computer servers (B.10) with interconnected workstations.

Process 1 (B.2) presents a form for the User to fill out that includes the following data elements:

Informational Data Elements:
Name of Video Program
Type of Video Program
Distribution Channel(s) for the Video Program
Language of Video Program
Sponsor of Video Program
Description of Video Program
Length of Video Program
Copyright Holder of Video Program
Copyright Date of Video Program

Digital Device Data Elements:
Digital Device Source of Video Program
Digital Device Source Interconnect on Workstation Running Process 1
Digital Device's File Name for Video Program

After the form is completed, the Process 1 asks the User to submit the form for processing:

Process 1 checks the above-listed informational data elements for proper format and accuracy against a list of entries valid for Database 1 (B.3).

Process 1 checks the above-listed digital device data elements for valid online status. Devices that are sources of digital video files (B.1) are connected as peripheral devices to computer workstations running Process 1.

If invalid entries are found, the Process sends the User back to the form with on-screen indications of entries that need to be corrected. The other Processes in Component 1 perform in the same way if invalid User-input data entries are found.

If no invalid entries are found, the Process then creates a new record in Database 1, and assigns that record and unique identification number.

Process 1 then uploads the digital video file of the video program from the source device to Database 1, and assigns it a digital video file name on the Database 1 server equivalent to the unique record number established in the above step. The file name is stored as a data element in the new record created for that file in Database 1 and, the informational data elements pertaining to the digital video file from the Process 1 form are added to the newly created Database 1 record.

Process 2 (B.4) presents the User with a form to fill out that includes the following data elements:
Video Format(s)
Video Bit Rate(s)
Audio Bit Rates(s)
Supplemental Content Bit Rate(s)
Video Screen Size(s)
Video Processing Options

Process 2 checks the above-listed data elements for proper format and accuracy against a list of valid entries for Database 2 (B.5).

If no invalid entries are found, Process 2 adds these data elements to the record established for the digital video file by Process 1, and queues the digital video file to be encoded based on the above-listed data elements and the informational data elements from the initial form.

Process 2 then encodes the digital video file for distribution over the Internet using streaming media technology video compression codec's.

Process 2 creates a new unique file name(s) for the resulting encoded file(s) by combining the unique file/record number name for the digital video file established by Process 1, with file name additions and extensions that signify the distribution format, bit rate, and screen size.

Process 2 then creates a new unique record(s) in Database 2 representing the new unique file name(s) created for the encoded file(s). It replicates all data elements from the record of its source file in Database 1 into the new record(s) established in Database 2.

Process 3 (B.6) presents the user with a form to fill out that includes the following data elements:
Distribution Channel(s)
Distribution Channel(s) Distribution Point Address on the Internet
Distribution Time Zone(s)
Distribution Date
Distribution Time
Distribution Cycle
Distribution Cycle End Date
Distribution Pre-processing Options

Process 3 validates the above information against a list of valid entries for Database 2 and, if no invalid entries are found, adds the information to each digital video file's record(s) created in Database 2 by Process 2. If the video program represented by the digital video file is to be transmitted repeatedly based on a cycle, the Process adds an additional record(s) for each repeat date and time, and replicates all other data elements into the new record(s). For any record where distribution pre-processing options are selected, Process 3 submits the digital video file for that processing by external software such as for audio language dubbing, titling, advertising insertion, and image enhancements.

Process 4 (B.7) runs for each channel for which there are digital video files in Database 2. Process 4 consists of a sub-process for each of the world-wide time zones. A time zone sub-process runs for each time zone for which there are programs scheduled to be distributed. A sub-process is initialized with the difference between its present system time, and the time in its target time zone. Operating as if its system time is the time in the target time zone, each sub-process sequentially scans Database 2 indexed by channel for the next digital video file to be distributed in the time zone serviced by the sub-process. It then issues commands to transmit the video program contained within the digital video file using streaming media technology to the distribution point on the Internet (B.8) for that channel. The distribution point on the Internet for a channel is a connection point on a server connected to the Internet (B.9). If no program is scheduled for an active channel at any given time in any given time zone, the relevant sub-process issues commands to transmit a digital video file with information about the next upcoming program based on the next entry in Database 2.

With reference to Drawing C, the detailed architecture of Component 2 of the Invention is structured as follows:

Component 2 of the Invention consists of a computer software program, called a Process in this document (C.1).

Component 2 operates on Internet-attached servers (C.2). People connect to such servers using Internet-attached devices such as computers, computer-enabled televisions, personal digital assistants, cell phones, and other wired and wireless devices running industry-standard Internet browsing software (C.3). People browse and connect to specific server addresses for the purpose of watching video programs from a specific source, or channel. People watch video programs using industry-standard streaming media player software.

All wired and wireless computing and communications devices running industry-standard browsing software or streaming media players have operating systems that keep track of date and time, often referred to as “system time,” which is reported as a system variable that can be used as a data element within software running on the operating system. In addition to system time, the operating system may also maintain a setting indicating the number of hour's difference between its system time and GMT, often referred to as the “time zone offset.”

Component 2 starts its operation after a person connects to a server, and chooses a channel of video programs to watch (C.4). The Component 2 Process captures the operating system type and the system time of the device used by the person to connect to the server (C.5). It also captures the time zone offset, if available; if not, it calculates the time zone offset. It does so by referencing an industry-standard Internet-based source for GMT (C.6), and calculating the difference between the time reported by that source and the system time.

If the operating system type is that of a wireless device connected to the Internet by cellular-based transmissions, such as a cell phone equipped with an Internet browser and streaming media player, then the Process adopts as definitive the date, time, and time zone offset reported by or calculated from the operating system.

If the operating system type is that of a wired or wireless device connected to the Internet by non-cellular connectivity, such as a computer connected to a wired or wireless network using Internet Protocol, and assigned an IP address, then the Process runs an additional sub-process to cross check the time zone offset. The sub-process captures the device's IP address reported by its operating system (C.5). The sub-process then uses an industry-standard Internet-based IP address locator service (C.7) to determine the geographic location of the IP address, along with its time zone offset and data confidence level as reported by the service. It then compares this information with the time zone offset information captured or calculated from the operating system. If the two sources for time zone offset do not agree, the sub process adopts the time zone offset from the IP address locator service provided that the data confidence level reported from the service is above 95%, otherwise, the process adopts the time zone offset captured or calculated from the operating system.

After capturing or calculating and adopting the time zone offset variable, Component 2 uses the offset to determine the time zone from which the device connects to the Internet. Component 2 then automatically connects the viewer's device and media player to the video program distribution point that contains the video program (C.8), transmitted by Component 1 of the Invention and delivered via the Internet and streaming media technology (C.9), designated for his or her time zone for the channel the viewer selected.

As noted above, the preceding description refers to video programs, files, and related devices, but the description applies as well to audio programs, files, and related devices. Video programs and audio programs include additional multimedia content that is related to and transmitted with the video or audio program.

What is claimed is:

1. A software program and method to automatically manage and distribute, via the Internet, digital audio, video, and related multimedia content that is specifically designated for viewing or listening by people with devices operating in a particular worldwide time zone.

2. A software program and method to automatically attach Internet-connected multi-media viewing devices to digital audio, video, and related multimedia content that is specifically managed and distributed for viewing or listening in the time zone for which the operating system of the device is set.

3. A software program and method to distribute audio, video, and related multimedia content on the Internet designated for a specific time zone so that such content is only received by Internet devices operating in that time zone.

4. A software program and method, as recited in claim 3, to distribute audio, video, and related multimedia content on the Internet designated for the time zone GMT, or GMT−1 hour, or GMT−2 hours, or GMT−3 hours, or GMT−4 hours, or GMT−5 hours, or GMT−6 hours, or GMT−7 hours, or GMT−8 hours, or GMT−9 hours, or GMT−10 hours, or GMT−11 hours, or GMT−12 hours, so that such content is only received by Internet devices operating in the designated time zone.

5. A software program and method, as recited in claim 3, to distribute audio, video, and related multimedia content on the Internet designated for the time zone GMT, or GMT+1 hour, or GMT+2 hours, or GMT+3 hours, or GMT+3.5 hours, or GMT+4 hours, or GMT+4.5 hours, or GMT+5 hours, or GMT+5.5 hours, or GMT+5.75 hours, or GMT+6 hours, or GMT+6.5 hours, or GMT+7 hours, or GMT+8 hours, or GMT+9 hours, or GMT+9.5 hours, or GMT+10 hours, or GMT+11 hours, or GMT+12 hours, or GMT+13 hours, so that such content is only received by Internet devices operating in the designated time zone.
